(19) United States
(12) Patent Application Publication
(10) Pub. No.: US 2010/0300984 A1
(43) Pub. Date: Dec. 2, 2010

(54) Nanostructured Carbon Supported Catalysts, Methods Of Making, And Methods Of Use

(76) Inventors: James R. Kastner, Athens, GA (US); Praveen Kolar, Raleigh, NC (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/788,410

(22) Filed: May 27, 2010

Related U.S. Application Data
(60) Provisional application No. 61/181,478, filed on May 27, 2009.

(51) Int. Cl. B01J 21/18; B01J 23/755; B01J 23/75; B01J 23/745; B01J 37/34; B01D 53/72; C02F 1/72; C02F 103/02; C02F 103/06

(52) U.S. Cl. 210/763; 502/100; 502/180; 502/300; 502/337; 502/325; 502/338; 502/5; 423/245.3

(57) ABSTRACT

Embodiments of the present disclosure relate to nanostructured carbon supported catalysts, methods of making nanostructured carbon supported catalysts, and methods of using nanostructured carbon supported catalysts.

### CROSS-REFERENCE TO RELATED APPLICATION

This application claims priority to co-pending U.S. provisional application entitled “Nanostructured Carbon Supported Industrial Catalysts and Methods of Making” having Ser. No. 61/181,478 filed on May 27, 2009, which is entirely incorporated herein by reference.

### STATEMENT REGARDING FEDERALLY SPONSORED RESEARCH OR DEVELOPMENT

Aspects of this invention may have been made with government support under Hatch: Development of a Biorefinery Process for Energy Production, Value Added Products, and Advanced Catalysts, GEO00546 0202684. The government may have certain rights in the invention(s).

### BACKGROUND

In poultry rendering, poultry wastes such as feathers, offal, dead birds, blood, and hatchery by-products are converted into value-added products, such as feed additives and fertilizers. The process involves hydrolyzing the raw materials in a batch mode at 140° C. to 150° C. (276 to 345 kPa) for 20 to 45 min. Under these conditions, volatile organic compounds (VOCs), such as aldehydes, and organic sulfur compounds, such as dimethyl sulfides, are generated. These aldehydes are not only associated with negative odors but also contribute to atmospheric ozone and particulate matter formation.

Typically, chemical wet scrubbers are used to treat the VOCs. However, on-site analysis of wet scrubbers indicated low efficiencies when treating aldehydes (typically <50% removal) due to lack of reactivity between the aldehydes and ClOC₂. Although other potential treatment technologies, such as adsorption, incineration, and biological filtration, are available, each technology has limitations. Adsorption only transfers and concentrates the VOCs from a gas phase onto a solid phase and needs further treatment for complete removal. Incineration processes, which involve combustion of the VOCs at high temperatures (1000° C. to 1200° C.) using natural gas as a fuel source are not only cost intensive, but also contribute to the production of greenhouse gases. Biological filtration systems, on the other hand, need longer residence times (typically 15 to 60 s) and thus require large reactors and cannot handle VOC fluctuations. Hence, an effective alternative technology is needed to treat the aldehyde fraction from rendering emissions.

Catalytic oxidation has emerged as one of the promising alternative technologies to treat VOCs emitted from various industries. The process involves a surface reaction between VOCs and an oxidant, aided by the presence of a catalyst. The use of the catalyst lowers the oxidation temperatures by providing alternate routes to end products whose activation energies are less than that of non-catalytic reactions. Additionally, the presence of a catalyst increases the reaction rate even at lower temperatures, resulting in lower treatment costs.

Because the reaction between VOCs and the oxidant occurs on the catalyst surface, efforts have been made to increase the available surface area of the catalysts. In these processes, the catalysts were used as either fine particles or powders; however, when used as powders or fine particles, the catalysts were prone to sintering at higher temperatures (typically greater than 500° C.), thereby inactivating the catalyst.

### SUMMARY

Briefly described, embodiments of the present disclosure include nanostructured catalyst comprising a support and catalyst particles, where the catalyst particles are dispersed on the support.

Embodiments of the present disclosure provide for a method of making a nanostructured catalyst comprising depositing catalyst particles onto a support using electrochemical deposition.

In embodiments of the present disclosure, a method of using a nanostructured catalyst is selected from the group consisting of: air pollution control, synthesis of liquid fuels, and waste water pollution control.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a general schematic of the device used to electrochemically deposit nickel and iron on activated carbon and the conditions used in the deposition experiments (note: the deposited metals/catalysts were subsequently calcined to generate the oxide of the metals).

FIG. 2 illustrates a schematic of a continuous flow system used for measurement of catalytic activity of embodiments of the present disclosure.

FIG. 3 is a graph that illustrates adsorption breakthrough curve for 130 ppmv propanal on pelleted activated carbon at 25° C. (n=1).

FIG. 4 illustrates typical fractional removal (0.70) obtained when PAC was tested at 25° C. for removal of 150 ppmv of propanal with 1500 ppmv of ozone (n=1).

FIG. 5 is a graph that illustrates the effect of propanal concentration on overall oxidation rate when tested with 2 g of PAC at 25° C. using 1500 ppmv of ozone as an oxidant (n=5 to 8).

FIG. 6 illustrates a comparison of PAC deposited with iron oxide with PAC (control, n=7). The oxidation rates of propanal when tested with PAC deposited with iron in DIW (n=5), in acetone (n=5), and iron oxide deposited on ozone-treated PAC using DIW were significantly less than that of PAC.

FIG. 7 illustrates a comparison of PAC electrochemically deposited with nickel and cobalt oxides with PAC (control, n=7). The oxidation rates of propanal when tested with PAC deposited with nickel (n=5) and cobalt (n=3) were significantly higher than that of PAC.

FIG. 8 illustrates a sample SEM micrograph and energy dispersive spectroscopic (EDS) analysis of pelleted activated carbon electrochemically deposited with cobalt oxide (top) and nickel oxide (bottom).

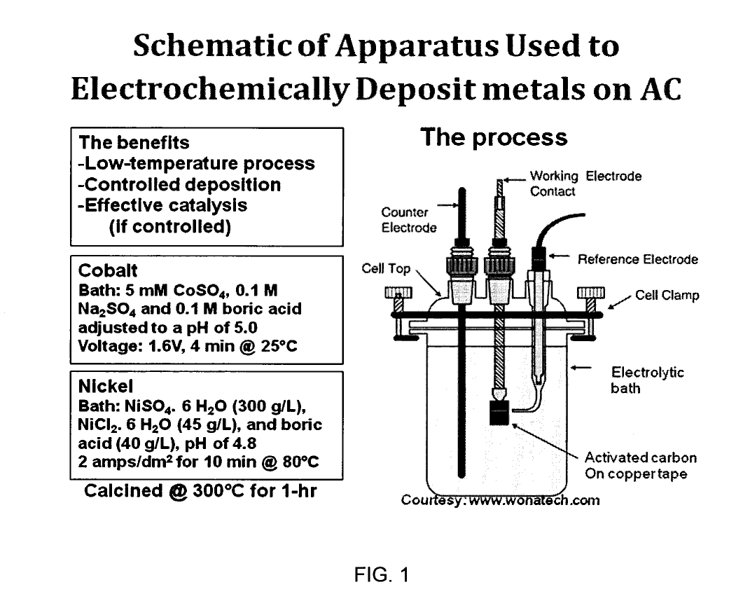

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion

In accordance with the purpose(s) of the present disclosure, as embodied and broadly described herein, embodiments of the present disclosure, in one aspect, relate to nanostructured carbon supported catalysts, methods of making nanostructured carbon supported catalysts, and methods of using nanostructured carbon supported catalysts. In an embodiment, the nanostructured catalysts may be used for the abatement of volatile organic compounds (VOC's) (e.g., aldehydes (e.g., propanal)) and organic sulfur compounds (e.g., dimethyl sulfides). VOC's can include both man-made (i.e., arising from solvents, paints, protective coatings, adhesives, and the like) and naturally occurring (i.e., arising from plants) chemical compounds. They have significant vapor pressure and can adversely affect the environment and human health. Organic sulfur compounds can include organic compounds containing sulfur (e.g., thiols, disulfides, polysulfides).

An embodiment of the present disclosure can include nanostructured catalysts comprising a support and catalyst particles, where the catalyst particles are dispersed on the support. Nanostructured catalysts are materials with active particles or films that are about 0.1 to 100 nm, in diameter and thickness, respectively. Catalytic activity of the particles or films can vary depending on their size, type, and the component to be abated. Synthesis of nanostructured catalysts may include deposition of nano-sized particles or films on support material or synthesis of the entire catalyst architecture at the nano-scale (e.g., about 100 nm or less).

Embodiments of the present disclosure can include nanostructured catalysts, where the catalyst is a film or particle(s) on the support surface. Embodiments of the present disclosure can include nanostructured catalysts, where the catalyst particles or film is made of a material such as metals, metal oxides, metal alloys, and a combination thereof. In an embodiment, the catalyst particles can be nickel or nickel oxide. In another embodiment, the catalyst particles can be cobalt or cobalt oxide. In another embodiment, the catalyst particles can be iron or iron oxide. The particles can have a diameter of about 0.1 to 100 nm.

An embodiment of the present disclosure can include nanostructured catalysts comprising a support that has a high surface area of about 500-2000 m²/g. The performance of the catalyst can be improved by dispersing (e.g., by electrochemical deposition) the particles on and/or in a support that has a high surface area. This not only prevents sintering, which inactivates the catalyst, but also allows for recovery of the catalyst after the reaction.

An embodiment of the present disclosure can include nanostructured catalysts comprising a support of activated carbon, biochar, or a combination thereof. Biochar is defined as a carbon material generated from biomass via low temperature (e.g., about 400-600° C.) pyrolysis process. Biochar is an amorphous carbon with lower surface area than activated carbon, but does not require further activation with oxidation agents (e.g., steam or CO₂) or chemical activation (e.g., phosphoric acid). Activated carbon is a type of carbon that has been processed to make it porous and, as a result, has a high surface area. Pyrolysis is defined as the heating of biomass (as defined later) in the absence of oxygen.

In an embodiment, the activated carbon comprises pelleted activated carbon (PAC). In an embodiment, the PAC can have a diameter of about 0.8 mm. In another embodiment, the PAC can be granular or shaped carbon particle size of about 0.3-3.0 mm. In an embodiment, the biochar comprises a pelleted (pelleted biochar or PBC), granular, or powdered form. PAC is advantageous because of its high surface area (e.g., 500-200 m²/g), high adsorption capacities for organic compounds, which can vary with the type of compound, and structural integrity. PBC is advantageous because of its lower cost, high adsorption capacities for organic compounds, which can vary with the type of compound, and structural integrity.

Embodiments of the present disclosure can include nanostructured catalysts, where the support of activated carbon or biochar is derived from biomass. Biomass is defined as organic material derived from plants (e.g., pine, peanut hulls) composed primarily of hemicellulose, cellulose, and lignin.

Embodiments of the present disclosure can include a method of making nanostructured catalysts that includes depositing catalyst particles onto a support using electrochemical deposition, such as that described herein. Electrochemical deposition allows for coating the entire surface of the support with a thin layer of material such as metal, which can optionally be oxidized. Electrochemical deposition may be used to synthesize particles of various sizes (e.g., about 0.1 nm to 100 nm in diameter), or to form a film of varying thickness (e.g., about 0.1 to 100 nm).

Electrochemical deposition can include an electroplating bath including the selected ion to be deposited where the pH can be generally acidic (e.g., about 1-6.9) and applying a potential (e.g., about 0.5 to 4 V). Deposition can be carried out at about room temperature to about 80° C. for about 2 to 20 minutes. The variables such as pH, potential, temperature, and time can be adjusted depending upon the components in the solution, the electrochemical setup, and the like.

Embodiments of the present disclosure can include a method of making nanostructured catalysts by depositing catalyst particles or films onto a support where the deposition occurs at about room temperature and about atmospheric pressure.

Embodiments of the present disclosure can include methods of using nanostructured catalysts including exposing a component to the nanostructured catalyst and oxidizing the component. In an embodiment, the component includes volatile organic compounds (VOC's). Embodiments of the present disclosure can include methods of using nanostructured catalysts for air pollution control, which includes the treatment of VOC's.

The process involves a surface reaction between VOCs and an oxidant, aided by the presence of a catalyst. The use of the catalyst lowers the oxidation temperatures by providing alternate routes to end products whose activation energies are less than that of non-catalytic reactions. Additionally, the presence of a catalyst increases the reaction rate even at lower temperatures, resulting in lower treatment costs.

Embodiments of the present disclosure include methods of using nanostructured catalysts including waste water pollution control. In an embodiment, waste water pollution control includes the treatment of hazardous and toxic compounds in industrial waste water or groundwater by exposing the waste water to the nano-catalyst in an environment where the waste water pollutants are oxidized by the catalyst.

Embodiments of the present disclosure include methods of using nanostructured catalysts including the synthesis of liquid fuels. In an embodiment, the liquid fuels can be methanol, ethanol, diesel, and catalytic upgrading of bio-oil to liquid fuels. Bio-oil is a crude oil generated from the pyrolysis of biomass. For example, nickel and cobalt supported catalysts can be used in a process called catalytic transfer hydrogenolysis, in which an organic hydrogen donor (e.g., isopropanol or formic acid; opposed to gaseous H₂) is used to deoxygenate aromatic alcohols to aromatic hydrocarbons. For example, the formic acid in bio-oil can be used and coupled with nickel or cobalt supported catalyst to convert aromatic alcohols in bio-oil to aromatic hydrocarbons (i.e., liquid fuels). In a similar process, palladium supported metals can be used to deoxygenate aromatic alcohols in bio-oil to aromatic hydrocarbons using gaseous H₂ at high temperatures and pressures (e.g., 200-300° C., 5 MPa). For example, cobalt, iron, iron alloy catalysts are used to convert synthesis gas (mixture of CO and H₂) to diesel fuel, gasoline, and waxes (Fischer-Tropsch process). Synthesis gas can be produced from biomass gasification.

Embodiments of the present disclosure are advantageous because a lower reaction temperature (e.g., room temperature) can be used, which not only lowers the treatment costs, but also reduces the production of green house gases and micro-pollutants (e.g., dioxins, phosgene).

### EXAMPLES

In poultry rendering, poultry wastes such as feathers, offal, dead birds, blood, and hatchery by-products are converted into value-added products, such as feed additives and fertilizers (J. Air Waste Mgmt. Assoc. (2002) 52(4): 459-469, which is herein incorporated by reference for the corresponding discussion). The process involves hydrolyzing the raw materials in a batch mode at 140° C. to 150° C. (276 to 345 kPa) for 20 to 45 min. Under these conditions, volatile organic compounds (VOCs), such as aldehydes, and organic sulfur compounds, such as dimethyl sulfides, are generated (J. Air Waste Mgmt. Assoc. (2002) 52(4): 459-469; J. Air Waste Mgmt. Assoc. (2003) 53(10): 1218-1224, which are herein incorporated by reference for the corresponding discussion). These aldehydes are not only associated with negative odors (J. Food Lipids (1999) 6(1): 47-61; Water Sci. Tech. (1988) 20: 55-61, which are herein incorporated by reference for the corresponding discussion), but also contribute to atmospheric ozone and particulate matter formation (Environ. Health Perspect. (2002) 110(supp. 4): 505-526, which is herein incorporated by reference for the corresponding discussion).

Typically, chemical wet scrubbers are used to treat the VOCs. However, on-site analysis of wet scrubbers indicated low efficiencies when treating aldehydes (typically <50% removal) due to lack of reactivity between the aldehydes and ClO₂ (J. Air Waste Mgmt. Assoc. (2003) 53(10): 1218-1224, which is herein incorporated by reference for the corresponding discussion). Although other potential treatment technologies, such as adsorption, incineration, and biological filtration, are available, each technology has limitations. Adsorption only transfers and concentrates the VOCs from a gas phase onto a solid phase and needs further treatment for complete removal (J. Hazardous Materials (2004) 109: 113-139, which is herein incorporated by reference for the corresponding discussion). Incineration processes, which involve combustion of the VOCs at high temperatures (1000° C. to 1200° C.) using natural gas as a fuel source (Catalysis Today (2000) 60(1-2): 129-138, which is herein incorporated by reference for the corresponding discussion) are not only cost intensive but also contribute to the production of greenhouse gases (Applied Catalysis B: Environ. (2003) 46(2): 371-379, which is herein incorporated by reference for the corresponding discussion). Biological filtration systems, on the other hand, need longer residence times (typically 15 to 60 s) and thus require large reactors and cannot handle VOC fluctuations. Hence, an effective alternative technology is needed to treat the aldehyde fraction from rendering emissions.

Catalytic oxidation is emerging as a promising alternate technology to treat VOCs emitted from various industries (Catalysis Today (1996) 29: 449-455, which is herein incorporated by reference for the corresponding discussion). The process involves a surface reaction between VOCs and an oxidant, aided by the presence of a catalyst. The use of the catalyst lowers the oxidation temperatures by providing alternate routes to end products whose activation energies are less that that of non-catalytic reactions (Smith. J. M. 1981. Chemical Engineering Kinetics. New York, N.Y.: McGraw-Hill, which is herein incorporated by reference for the corresponding discussion). Additionally, the presence of a catalyst increases the reaction rate even at lower temperatures, resulting in lower treatment costs.

Because the reaction between VOCs and the oxidant occurs on the catalyst surface, efforts have been made to increase the available surface area of the catalysts. In these processes, the catalysts were used as either fine particles or powders (Carbon (1999) 37(4): 631-637, which is herein incorporated by reference for the corresponding discussion); however, when used as powders or fine particles, the catalysts were prone to sintering at higher temperatures (typically greater than 500° C.), thereby inactivating the catalyst. One method for improving the performance of the catalyst is by dispersing catalyst particles on a support that has a high surface area. This would not only prevent sintering but also allow for recovering the catalyst after the reaction. Traditionally, inorganic materials such as silica and alumina are used as supports for dispersing catalysts. However, under humid and low pH conditions, these supports tend to become unstable and become deactivated (Carbon (2005) 43(15): 3041-3053, which is herein incorporated by reference for the corresponding discussion). Recently, activated carbon has been used as a catalyst support because of its stability, availability, and higher surface area (500 to 2000 m²/g). If the same catalysts are dispersed on activated carbon, then the activity of the catalyst could increase significantly due to increased availability of exposed catalytic sites.

Efforts have been made in the recent past towards development of highly active catalysts. Researchers such as Gomez, et al. (Applied Catalysis B: Environ. (1999) 20(4): 267-275, which is herein incorporated by reference for the corresponding discussion) synthesized high surface area catalysts by dispersing metal on high surface area supports, thereby increasing the effective surface area and catalytic activity. However, with advances in nanotechnology and textural characterization techniques, more recent efforts are focused towards development of nanostructured catalysts. Nanostructured catalysts are catalytic materials that typically contain active particles or film ranging between 0.1 to 100 nm. Synthesis of nanostructured catalysts may include deposition of nano-sized particles or films on support material or synthesis of the entire catalyst architecture at the nano-scale. The physical, chemical, and electronic properties of materials change as the size approaches the nano-level (Chem. Rev. (2004) 104(1): 293-346; Critical Reviews in Environ. Sci. and Tech. (2006) 36(5): 405-431, which are herein incorporated by reference for the corresponding discussion). These properties are being utilized in many medical (Sensors and Actuators B (2006) 114(1): 379-386, which is herein incorporated by reference for the corresponding discussion), electronic (J. Chem. Eng. Japan 38(8): (2005) 535-546, which is herein incorporated by reference for the corresponding discussion), and catalytic (J. Catalysis (2005) 234(2): 348-355, which is herein incorporated by reference for the corresponding discussion) applications. Some of the material properties that could be manipulated for applications in heterogeneous catalysis are based on altering surface structure, catalytic activity, and size.

Typical techniques for synthesizing nanostructured catalysts include dispersion of metal phase by impregnation, precipitation, and chemical vapor deposition. Impregnation and precipitation techniques are well studied, but the control of the particle size is difficult. Chemical vapor deposition is expensive and mainly used in the electronics and semiconductor industries. Electrochemical deposition (ED), on the other hand, is promising because it is inexpensive, does not require high temperature, requires only low metal concentrations, and can potentially be used to synthesize particles of various sizes. ED would allow for control of the chemical and catalytic properties of the materials that are deposited (Electrochimia Acta (2003) 49(1): 51-61, which is herein incorporated by reference for the corresponding discussion). For example, electrochemical techniques have been used to synthesize magnetic nanoparticles on carbon nanowall templates (Nanoletters (2002) 2(7): 751-754, which is herein incorporated by reference for the corresponding discussion). Similarly, binary manganese-cobalt oxides were deposited on graphite substrates (Materials Chem. and Physics (2005) 92(1): 138-145, which is herein incorporated by reference for the corresponding discussion). Recently, activated carbon was used as a substrate to deposit precious metals. Kumar, et al. (J. Molecular Catalysis A: Chemical. (2004) 223: 313-319, which is herein incorporated by reference for the corresponding discussion) described synthesis of microcrystals on activated carbon via electrochemical deposition. Additionally, platinum nanocrystals were generated on activated carbon surface by Adora, et al. (J. Phys. Chem. B (2001) 105(43): 10489-10495, which is herein incorporated by reference for the corresponding discussion).

However, electrochemical deposition techniques have not been used to synthesize catalysts for VOC abatement (note, the same can be said of wastewater treatment and chemical synthesis; e.g., liquid fuels). Hence, a goal of this research was to develop highly active metal oxide catalysts by impregnation and electrochemical deposition techniques for treating aldehydes emitted from poultry rendering emissions. For this project, propanal was chosen as a representative aldehyde because of its limited reactivity with catalysts and oxygen at ambient temperatures, its role as a primary air pollutant in rendering emissions, and its offensive odor (Environ. Sci. Tech. (2008) 42(2): 556-562, which is incorporated by reference for the corresponding discussion). Similarly, oxides of iron, nickel, and cobalt were used as model catalysts because of their documented catalytic activities in oxidizing VOCs (Environ. Sci. Tech. (2008) 42(2): 556-562; Applied Catalysis A: General (2006) 298: 109-114; Chem. Eng. J. (2006) 122(1-2): 41-46, which are herein incorporated by reference for the corresponding discussion). Some of our specific objectives were to: (1) deposit nickel and cobalt oxide on activated carbon supports using electrochemical deposition, (2) synthesize iron oxide on activated carbon supports using traditional impregnation, and (3) test the catalysts for treatment of propanal vapors.

### Experimental Methods

Synthesis of Catalysts

### Pelleted Activated Carbon (PAC)

Commercially available pelleted activated carbon (PAC) (Norit RO 0.8 extruded activated carbon, rod shaped, 0.8 mm diameter, generated from peat and steam activated; Norit Americas, Inc., Marshall, Tex.) was used as a catalyst and a support to deposit iron, nickel, and cobalt oxides. Prior to use, the PAC was cleaned with deionized water (DIW) three times to remove finely suspended carbon particles. The washed PAC was then soaked for 24 h in 5% HCl, as described by Hu, et al. (Carbon (1999) 37(4): 631-637, which is herein incorporated by reference for the corresponding discussion). Subsequently, the PAC was washed with DIW three times and dried at 105° C. for 8 h and stored in airtight containers.

### Electrochemical Deposition of Nickel and Cobalt Oxides on PAC

In this step, the PAC was used as a support for depositing nickel and cobalt. The synthesis was carried out in a 200 mL glass beaker that contained a reference electrode, working electrode, and a platinum counter electrode. The electroplating bath for cobalt consisted of a solution of 5 mM CoSO₄, 0.1 M Na₂SO₄, and 0.1 M boric acid adjusted to a pH of 5.0. The PAC pellets were mounted on a two-sided copper tape, which acted as a cathode (working electrode). A potential of 1.6 V was applied across the electrodes, and deposition was carried out for 4 min at room temperature (25° C.) while the bath was constantly stirred at 6 rpm. For nickel plating, a bath consisted of NiSO₄.6H₂O (300 g/L), NiCl₂.6H₂O (45 g/L), and boric acid (40 g/L) adjusted to a pH of 4.8 was used. Deposition was carried out for 10 min at 60° C. with constant stirring at 6 rpm with a constant current density of 3 A/dm². After deposition, the pellets were removed from the copper tape, washed with DI water, and dried at 105° C. for 8 h. Subsequently, the catalysts were calcined at 300° C. for 1 h in a furnace with an airflow of 10 L/min.

The above procedure was not effective when iron nitrate was used as a precursor for depositing iron oxides on PAC. Thus, a traditional impregnation method was used to synthesize iron oxide catalysts on PAC.

### Traditional Impregnation of Iron Oxide on PAC

Iron oxide was deposited on PAC via three different methods. In all the methods, the final metal loading on PAC was maintained at 10% (w/w). In the first method, the precursor salt, 8 g of iron nitrate (Fe(NO₃)₃.9H₂O), was dissolved in 10 mL DIW. Ten grams of cleaned and 5% HCl washed PAC was soaked in the above prepared solution for 8 h. The sample was dried at 105° C. in an air convection oven for 8 h. The dried sample was calcined at 300° C. for 1 h in a furnace with an airflow of 10 L/min.

As mentioned above, DIW was used as a solvent to dissolve the precursor salt. However, activated carbons are known to be hydrophobic and hence, in the above described method of catalyst synthesis, the DIW might not have completely wetted the surface and iron might not have adsorbed on the PAC surface. In order to improve wetting of the PAC surface and deposition of iron, acetone was used as a solvent in the second method while the precursor loading, drying, and calcination conditions were identical to the previous methods.

In the third method, the effect of ozone was tested. Ozone was recently used to enhance the adsorption capacity of polar compounds and add carboxylic and oxygen functional groups to activated carbon surfaces (Chemosphere (2002) 47(3): 267-275, which is herein incorporated by reference for the corresponding discussion). Ozonation of activated carbon and its effects on the adsorption of VOCs exemplified by methylethylketone and benzene. We theorized that exposing PAC to ozone might (1) add oxygen functional groups on the surface and hence water could wet more readily and (2) generate other functional groups (e.g., carboxylic acid groups), which might increase the interaction between the salt precursor and the PAC surface. In this method, the PAC was exposed to 1500 ppmv of ozone for 8 h. Subsequently, the PAC was deposited with iron oxide as described in the first method.

### Catalyst Characterization

The physical and chemical properties of the PAC were determined and included pH, density, and specific surface area (Table 1). The specific surface area was determined by a surface area analyzer (Nova 3000, Quantachrome Instruments, Boynton, Beach, Fla.) using the Brunauer-Emmett-Teller (BET) principle that measured the amount of nitrogen adsorbed on the sample surface at a constant temperature at various nitrogen pressures. The fundamental principles of the method are explained in detail by Brunauer, et al. (J. American Chem. Soc. (1938) 60(2): 309-319, which is herein incorporated by reference for the corresponding discussion). The samples were degassed at 100° C. for 8 h prior to surface area analysis.

TABLE 1
Physical properties of pelleted activated carbon used in this study.

| | Measured |
|---|---|
| Property | Value |
| Particle size (diameter × | 0.8 D × 3 to |
| length, mm) | 6 L |
| pH | 9.7 |
| Density (g/cc) | 1.01 |
| Original surface area (m²/g) | 784 ± 23 |
| Surface area after nickel | 653 ± 20 |
| deposition (m²/g) | |
| Surface area after cobalt | 649 ± 45 |
| deposition (m²/g) | |

For surface characterization, the samples were analyzed using a scanning electron microscope. Triplicate samples of catalysts were mounted on an aluminum stub covered with an adhesive carbon tab. The mounted samples were coated with ˜120 Å of gold using a sputter coater (model SPI, SPI Supplies, West Chester, Pa.). The gold-coated samples were imaged using a digital SEM (model 1450 EP, Carl Zeiss Micro Imaging, Thornwood, N.Y.). An accelerating voltage of 5 keV was used, and a back-scattering detector was used for imaging the samples. The elemental composition was determined using an energy dispersive analyzer. An accelerating voltage of 5.5 keV was used for 60 s for determination of elemental composition. Subsequently, the raw data were processed using Inca Energy software (Oxford Instruments, Inc., Oxfordshire, U.K.).

### Experimental Setup for Measurement of Catalytic Activity

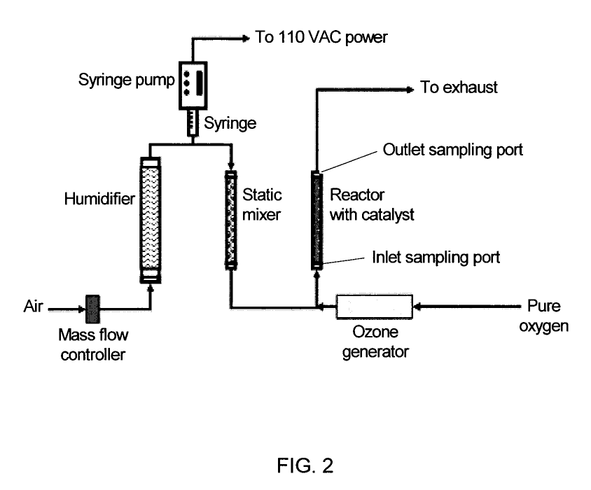

All experiments were performed in a continuous flow, packed-bed reactor system, as shown in FIG. 2. The system consisted of a series of cylindrical glass reactors for humidification (5 cm diameter), mixing (2.54 cm diameter), and catalytic oxidation (2.5 cm diameter) connected by 0.625 cm (ID) Teflon tubing. Compressed air was humidified (RH>78%) by passing the air through a water (humidification) column. The flow of air was controlled by a mass flow controller (8100 Series, Celerity, Inc., Allen, Tex.). Propanal was used as a model compound due to its recalcitrance to oxidation at room temperatures (oxidation using O₂ and using O₃ without a catalyst). Liquid propanal was injected into the system using an automated syringe pump (model 74900-30, Cole Parmer, Vernon Hills, Ill.) and a 10 cc disposable syringe (Becton Dickinson, Franklin Lakes, N.J.) at a predetermined rate to obtain the desired concentration. The injection rates varied between 0.3 and 2.3 μL/min to obtain a concentration of 20 to 250 ppmv at an overall flow rate of 6 L/min.

The humidified air and propanal vapor were allowed to mix in glass column packed with glass beads (3 mm diameter), and 1500 ppmv of ozone was added to the air-propanal mixture approximately 10 cm before the reactor inlet. Ozone was generated by flowing ultra high pure oxygen, (99.9% purity, National Welders Supply, Inc., Charlotte, N.C.) through an ozone generator capable of corona discharge (model OL100H/DS, Yanco Industries, British Columbia, Canada). A concentration of 1500 ppmv was chosen based on previous experiments (Environ. Sci. Tech. (2008) 42(2): 556-562, which is herein incorporated by reference for the corresponding discussion), where it was found that beyond a molar ration of 1:10 (propanal:ozone) the oxidation rate of propanal was independent of the ozone concentration. The ozone concentration (1500 ppmv) was based on manufacturer's specified instrument setting and the oxygen flow rate. However, based on our previous experience, the ozone generator setting was within ±5% of measured ozone concentration using an ozone analyzer.

After mixing, the air-aldehyde-ozone mixture flowed through a packed-bed reactor that contained 2 g of catalyst (1 g when nickel and cobalt oxides were used as catalysts). The top and bottom of the catalytic bed was also distributed with glass wool to promote plug flow conditions. The fractional removal was measured at 25° C. and 1 atm pressure. To attain a steady-state condition, propanal was injected overnight (12 h) before sampling the reactor. The inlet and outlet of the reactor were simultaneously sampled using gastight syringes (1 to 2 mL, VICI Precision Sampling, Inc., Baton Rouge, La.) and analyzed using a gas chromatograph (GC).

Samples were drawn from the reactor every 20 min and injected into a gas chromatograph to determine the concentrations. From the measured inlet and outlet concentrations, the fractional conversion (X) at each concentration regime was determined as:

$$X = [ \frac{{C}_{in} - {C}_{Out}}{{C}_{in}} ] \times 100 \% \qquad ( 1 )$$

The reaction rate for our assumed plug flow reactor model is expressed as (Elements of Chemical Reaction Engineering. (2006) 4th ed. Upper Saddle River, N.J.: Prentice Hall, which is herein incorporated by reference for the corresponding discussion):

$$- r = \frac{d {F}_{A}}{d W} \qquad ( 2 )$$

where F_{A} is the molar flow rate entering the reactor, and W is the mass of the catalyst. Additionally, the equation assumes that the inlet concentration, temperature, and reaction rate remain constant along the radial axis of the reactor and that the volumetric flow rate remains constant.

Assuming that steady-state, isothermal, and isobaric conditions and ideal gas laws were valid, the overall rate of aldehyde oxidation was determined by modifying and simplifying equation 2:

$$- r = Q \frac{P}{RT} y \frac{X}{W} \frac{1}{60} \qquad ( 3 )$$

where −r is the rate of oxidation of the aldehyde (mol/g-s), P is the pressure (atm), Q is the volumetric flow rate of the aldehyde-air mixture (L/min), R is the universal gas constant, T is the temperature (K), y is the inlet mole fraction, X is the fractional removal (generally <0.30 to reduce error in use of eq. 3), W is the mass of the catalyst (g).

### Analytical Methods

The inlet and outlet gas samples were analyzed using a Hewlett-Packard 5890 GC equipped with a flame ionization detector (FID) and a SPB-1 sulfur column (0.32 μm, 30 m) (Supelco, Bellefonte, Pa.). The samples were analyzed under isothermal conditions (column temperature of 80° C., inlet and detector temperatures of 200° C. and 250° C.) and a split ratio of 30:1. A sample size of 250 μL was used for the entire study. Standard curves of propanal were prepared for a concentration range of 0 to 200 ppmv using 1 L Tedlar bags and calibrated gas syringes (1 to 2 mL, VICI Precision Sampling, Inc., Baton Rouge, La.).

For all experiments, 5 to 8 samples of inlet and outlet were collected (n=5 to 8) for determination of propanal oxidation rates using equations 1 and 3. We also performed a two-sample t-test to compare PAC with PAC deposited with nickel oxide and PAC deposited with cobalt oxide.

### Results and Discussion

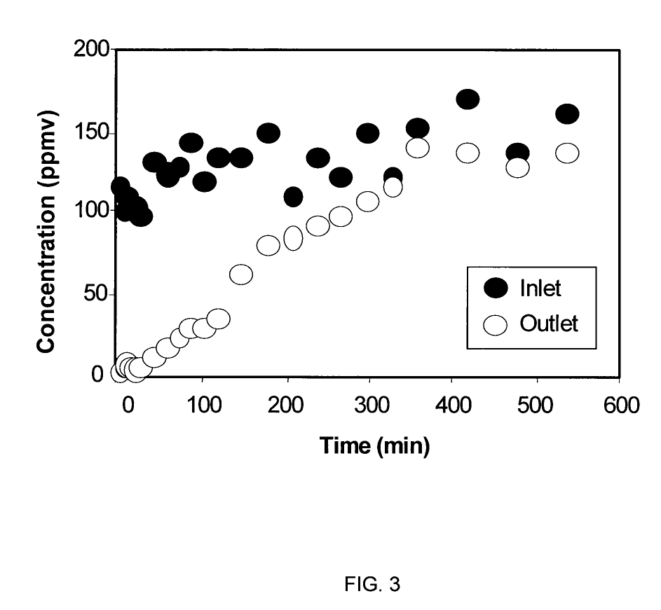

Activated carbons generally possess high surface area and are associated with high adsorption capacities. When used as a catalyst or as a catalyst support for VOC abatement, and we determined if the removal is due to adsorption or due to a catalytic reaction. Therefore, we conducted a simple experiment to determine the time required for the propanal to saturate and breakthrough the activated carbon bed. For this experiment, a constant propanal inlet concentration of approximately 130 ppmv was injected into the reactor system. Immediately upon injection, inlet and outlet samples were drawn periodically using gastight syringes and injected into a gas chromatograph, as described in the Methods section. For the first 20 min, the outlet concentrations were close to zero, indicating adsorption of propanal on the activated carbon surface (FIG. 3). Subsequently, the outlet concentration gradually increased and finally reached approximately 130 ppmv after 300 min. These results indicated that the effect of adsorption is negligible beyond 300 min. In all our subsequent experiments, an equilibration time of 12 h was used so that the measured difference in the inlet and outlet concentrations truly represented the effect of a catalytic reaction.

### Measurement of Catalytic Activity

Pelleted Activated Carbon (PAC)

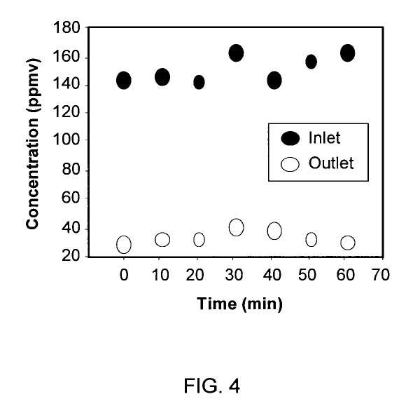

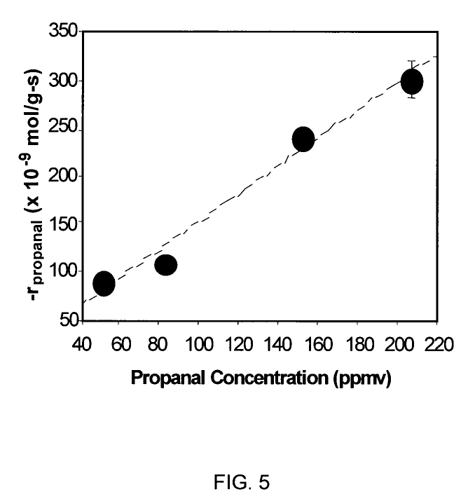

Initially, PAC alone was tested as a catalyst for treating 50 to 200 ppmv propanal vapors. Two grams of PAC was packed in the reactor, and 1500 ppmv of ozone was used as an oxidant. A fractional removal of 70% was obtained with PAC alone at 25° C. (FIG. 4), and the reaction rates increased with increasing propanal concentration and ranged between 90×10⁻⁹ and 300×10⁻⁹ mol/g-s (FIG. 5).

The propanal oxidation rates we obtained using the PAC alone were significantly higher than the rates obtained with similar aldehydes previously tested. For example, when 600 ppmv of acetaldehyde was oxidized to CO₂ using oxygen at 100° C. over CoOx-loaded SiO₂ xerogels, the reaction rates were in the order of 50×10⁻⁹ mol/g-s (Langmuir (2005) 21(6): 2273-2280, which is herein incorporated by reference for the corresponding discussion). In our work, when ozone was used as an oxidant, a significantly higher oxidation rate was observed at 25° C. In our earlier work with propanal (Environ. Sci. Tech. (2008) 42(2): 556-562, which is herein incorporated by reference for the corresponding discussion), we used granular activated carbon (GAC) to oxidize propanal at 25° C., and the propanal oxidation rates were ten times lower than the rates determined in this work. The higher oxidation rates obtained for PAC may be due to a variety of reasons. The higher activity of the PAC may have been due to the fact that, in our earlier work, the granular activated carbon had a surface area of 425 m²/g compared to the PAC used in the current work, which had a surface area of 784 m²/g. Moreover, the particle size of the PAC (0.8 mm dia.×3 to 6 mm long) was smaller than the granular activated carbon (4 to 8 mesh, or 2.4 to 4.75 mm dia.) tested in our earlier work, which could have increased the measured oxidation rate of PAC when compared to granular activated carbon (i.e., the smaller particle size may have reduced internal mass transfer resistance, and thus more of the surface area was available for catalytic activity). The higher activity of the PAC may have also been due to the higher ozone concentrations that were used (1500 ppmv for PAC vs. 100 ppmv for granular activated carbon). Finally, the higher activity of PAC may also be attributed to the differences in the carbon source used for generation of the activated carbon (extruded peat for PAC vs. acid-washed coal for GAC, both steam activated). However, it must be noted that the reaction rates calculated for PAC may not be completely accurate because the measured fractional removal (X) was greater than 30%, which was inconsistent with the differential reactor model assumption (eq. 3; fractional conversions of 0.25 or less, reportedly limits error in use of the differential reactor assumption to 5%; Smith. J. M. 1981. Chemical Engineering Kinetics. New York, N.Y.: McGraw-Hill, which is herein incorporated by reference for the corresponding discussion).

### Mechanism of Ozonation on PAC

Activated carbons are known to catalyze oxidation reactions, especially in the presence of ozone. For example, in an earlier work, we demonstrated oxidation of propanal at room temperature using granular activated carbon (Environ. Sci. Tech. (2008) 42(2): 556-562, which is herein incorporated by reference for the corresponding discussion). Ozone, as an oxidant, could have reacted with propanal in several ways. The reaction could have occurred between adsorbed ozone and propanal. Another possibility could be that the reaction occurred via an advanced oxidation process involving OH* radicals due to decomposition of ozone on the catalyst surface (M). Considering the high pH of the activated carbon (pH=9.7) and the presence of moisture in the air that carried propanal (RH≅78%), reaction between OH* radicals and propanal seems to be a likely possibility (Environ. Sci. Tech. (2008) 42(2): 556-562, which is herein incorporated by reference for the corresponding discussion).

As proposed by Hoigne (1998):

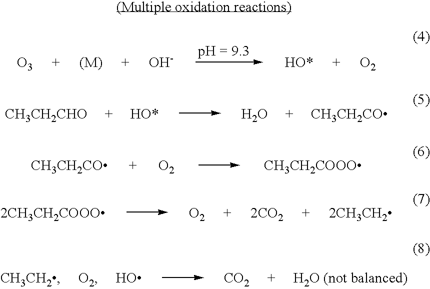

In the above chain reaction, the catalyst (M), in the presence of water, acts as an initiator to produce a hydroxyl radical (OH*). Among the free radicals formed during the ozone decomposition, the hydroxyl radical (OH*) is one of the most reactive (Hoigne, 1997) (10⁶ to 10⁹ M⁻¹ s⁻¹) and strongest oxidants (eq. 9). The hydroxyl radical continuously reacts with propanal and subsequently forms lower molecular weight VOCs, which are ultimately oxidized to form water and CO₂, as shown in equations 4 through 8, typically via hydrogen abstraction (Hoigne, 1998).

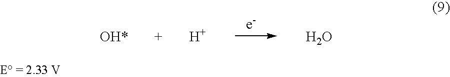

PAC Deposited with Iron Oxide Particles

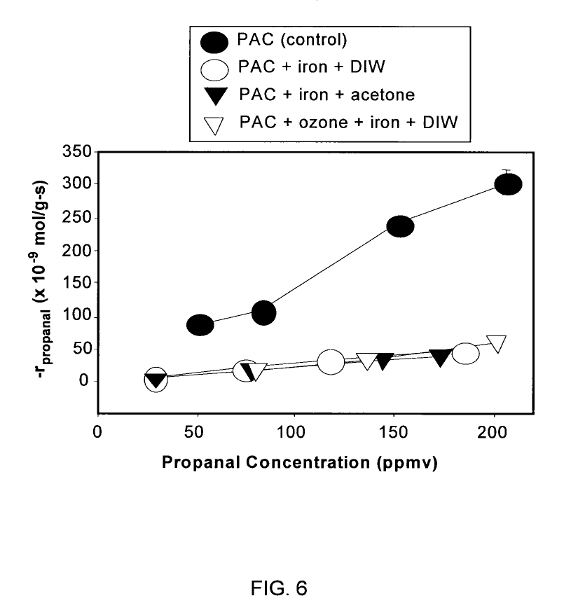

The iron oxide deposited PAC catalysts were tested under identical conditions as the control PAC. When tested, the activities of all three iron oxide catalysts were significantly lower than that of PAC (FIG. 6). The rates of all iron oxide catalysts were between 7×10⁻⁹ and 60×10⁻⁹ mol/g-s, which are an order less than PAC (Table 2). In our previous study on propanal oxidation using iron oxide catalysts, we clearly demonstrated significantly higher oxidation rates when compared to a control (granular activated carbon). However, in this case, the opposite is true. This may have been due to our deposition procedure, in which we speculate that the PAC pores were plugged by iron particles, which may have reduced the surface area. It may also be possible that the form of iron that was deposited on PAC may not be an oxide or catalytically active. Since we do not have x-ray diffraction analysis data for the prepared catalysts, it is not known what crystalline structure of iron actually formed during calcination.

TABLE 2
Propanal reaction rates at 25° C. using the following catalysts and 1500
ppmv of ozone.

| | | Reaction |
|---|---|---|
| | Conc. | rate |
| Catalyst | (ppmv) | (×10⁻⁹ mol/g-s) |
| Pelleted activated | 50-207 | 88-303 |
| carbon (PAC) | | |
| Cobalt on PAC | 50-190 | 111-365 |
| Nickel on PAC | 105-246 | 232-450 |
| Iron oxide on PAC | 27-186 | 8-48 |
| with DIW | | |
| Iron oxide on PAC | 28-173 | 7-40 |
| with acetone | | |
| Iron oxide on PAC | 80-202 | 20-62 |
| with DIW | | |
| (ozone treated) | | |

### Electrochemically Synthesized Nickel and Cobalt Oxides

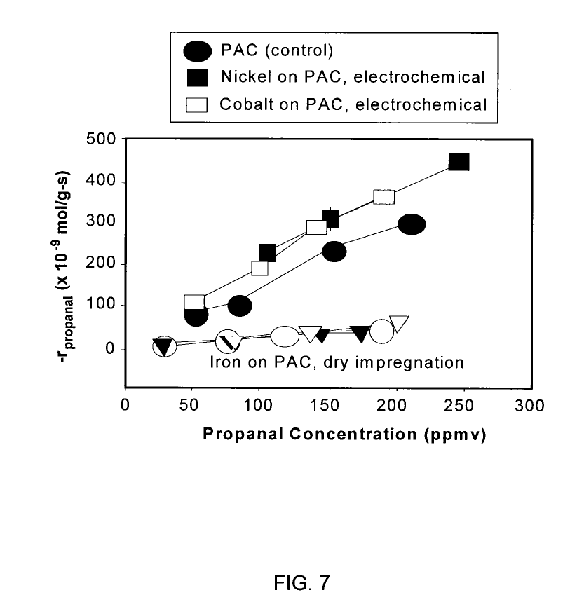

When tested, the nickel and cobalt carbon-supported catalysts, as expected, generated higher reaction rates than PAC alone (cobalt, P=0.01; nickel, P=0.03). At low concentrations (˜100 ppmv), the differences in rates were small (FIG. 7). However, as the concentration increased, the rate of propanal oxidation for the nickel and cobalt deposited catalysts increased when compared to PAC. Interestingly, the reaction rates of the cobalt and nickel deposited catalysts were similar (Table 2).

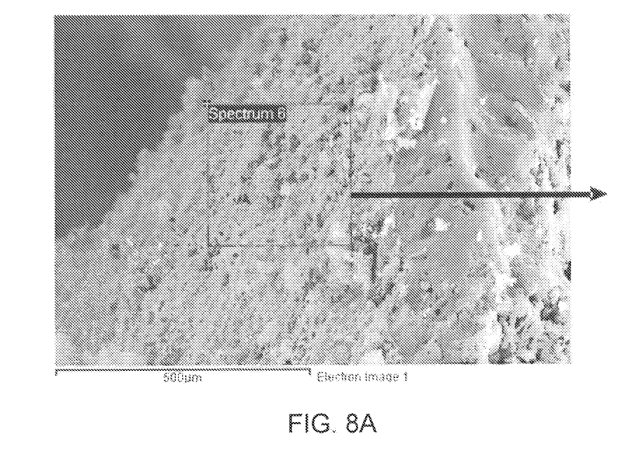

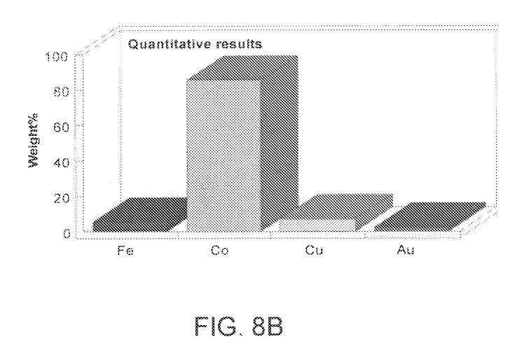

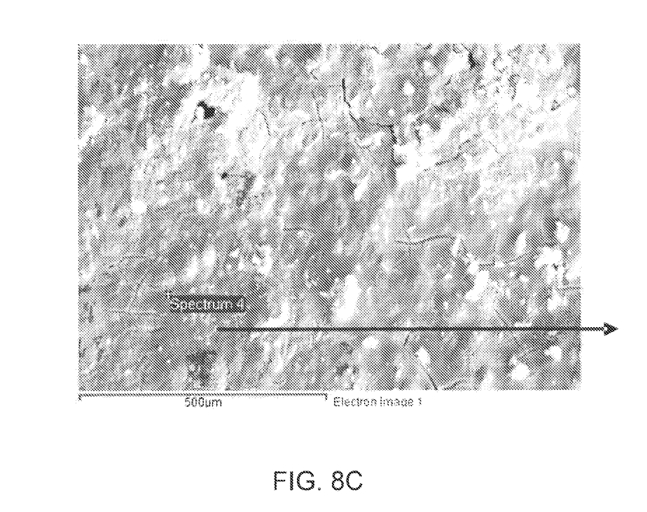

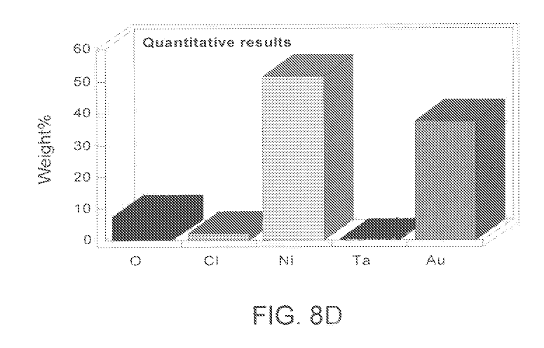

Oxides of nickel and cobalt are catalytically active due to their variable oxidation states. Based on our previous experience, metal oxide particles are also catalytically active for oxidation of VOCs in the presence of ozone (Environ. Sci. Tech. (2008) 42(2): 556-562, which is herein incorporated by reference for the corresponding discussion). Thus, we theorize that electrochemical deposition coated the surface of the PAC with a thin layer of metal (clearly noted in FIG. 8). Subsequently, the metal film was presumably oxidized into metal oxide, via calcination under oxidizing conditions, which was the active phase (see the Methods section). The SEM/EDS analysis of the catalyst surface indicated that films of nickel and cobalt were formed (FIG. 8). The bar charts in FIG. 8 indicate the elemental composition of the catalyst surface; for example, in the case of PAC deposited with cobalt, cobalt constituted 80% of the total surface. The metal oxide film formed via calcination under oxidizing conditions probably increased propanal oxidation activity by increasing the number of catalytic sites (or active atomic density) on the surface available for the oxidation reaction to occur. Based on our preliminary results, it appears that the catalysts synthesized via electrochemical deposition have higher activities for oxidation of propanal at room temperature, compared to PAC alone. However, to obtain the maximum activity for the catalyst, additional testing is needed to optimize the deposition parameters, such as the deposition time, applied current and voltage, and stirring speed.

The metal oxides probably act to catalyze the oxidation of propanal in a slightly different mechanism than activated carbon. The general consensus in the literature is that ozone dissociatively adsorbs onto metals (Pt, Pd, Rh) and metal oxides (Mn, Co, Cu, Fe, Ni), forming active oxygen species (O, O₂⁻; Applied Catalysis B: Environ. (1997) 11(2): 129-166, which is herein incorporated by reference for the corresponding discussion). Once formed, these oxygen radicals could enter into a free radical oxidation mechanism similar to that proposed for the activated carbon surface (eqs. 4 through 8).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are merely set forth for a clear understanding of the principles of the disclosure. Many variations and modifications may be made to the above-described embodiments. All such modifications and variations are intended to be included herein within the scope of this disclosure and protected by the following claims.

Therefore, at least the following is claimed:

1. A nanostructured catalyst comprising:
a support; and
catalyst particles, wherein the catalyst particles are dispersed on the support.

2. The nanostructured catalyst of claim 1, wherein the support has a high surface area of about 500-2000 m²/g.

3. The nanostructured catalyst of claim 1, wherein the support comprises activated carbon.

4. The nanostructured catalyst of claim 3, wherein the activated carbon comprises pelleted activated carbon (PAC).

5. The nanostructured catalyst of claim 3, wherein the activated carbon is derived from biomass.

6. The nanostructured catalyst of claim 1, wherein the support comprises biochar.

7. The nanostructured catalyst of claim 6, wherein the biochar is in a form selected from the group consisting of: pelleted (PBC), granular, powdered, and a combination thereof.

8. The nanostructured catalyst of claim 1, wherein the catalyst particles are selected from the group consisting of: a metal, a metal oxide, a metal alloy, and a combination thereof.

9. The nanostructured catalysts of claim 8, wherein the catalyst particles comprise a film on the support surface.

10. The nanostructured catalyst of claim 8, wherein the catalyst particles are selected from the group consisting of: nickel, nickel oxide, and a combination thereof.

11. The nanostructured catalyst of claim 8, wherein the catalyst particles are selected from the group consisting of: cobalt, cobalt oxide, and a combination thereof.

12. The nanostructured catalyst of claim 8, wherein the catalyst particles are selected from the group consisting of: iron, iron oxide, and a combination thereof.

13. The nanostructured catalyst of claim 1, wherein the catalyst particles are deposited onto the support by electrochemical deposition.

14. A method of making a nanostructured catalyst comprising:
depositing catalyst particles onto a support using electrochemical deposition.

15. The method of claim 14, wherein the support has a high surface area of about 500-2000 m²/g.

16. The method of claim 14, wherein the support is selected from the group consisting of: activated carbon, biochar, and a combination thereof.

17. The method of claim 16, wherein the support is derived from biomass.

18. The method of claim 14, wherein the catalyst particles are selected from the group consisting of: a metals, a metal oxide, a metal alloy, and a combination thereof.

19. The method of claim 14, wherein the deposition occurs at room temperature and atmospheric pressure.

20. A method of using a nanostructured catalyst, comprising
exposing a component to the nanostructured catalyst; and
oxidizing the component.

21. The method of claim 20, wherein the component includes volatile organic compounds (VOC's).

22. The method of claim 20, wherein the component includes waste water pollution.

23. The method of claim 22, wherein the waste water pollutant includes hazardous and toxic compounds in industrial waste water or groundwater.
